(19) United States
(12) Patent Application Publication
(10) Pub. No.: US 2026/0105021 A1
(43) Pub. Date: Apr. 16, 2026

(54) SERIAL COMMUNICATION DEVICE, SERIAL COMMUNICATION SYSTEM, AND SERIAL COMMUNICATION METHOD

(71) Applicant: HANGZHOU SHIXIN TECHNOLOGY CO., LTD, Hangzhou (CN)

(72) Inventors: Riyi CHEN, Hangzhou (CN); Lingjun KONG, Hangzhou (CN); Zheng LUO, Hangzhou (CN)

(21) Appl. No.: 19/145,772

(22) PCT Filed: Apr. 21, 2023
(86) PCT No.: PCT/CN2023/089880

§ 371 Date: Jul. 3, 2025

(30) Foreign Application Priority Data
Jan. 3, 2023 (CN) 202310000676.X

(51) Int. Cl. G06F 13/42

(52) U.S. Cl. CPC G06F 13/4282; G06F 13/4273

(57) ABSTRACT

Disclosed is a serial communication device, a serial communication system and a serial communication method. The serial communication device includes: a first shift register for receiving data based on a communication clock or a system clock; a second shift register for transmitting data based on the system clock; a data processing circuit for processing data based on the system clock. The serial communication device receives the communication clock and the system clock, the communication clock is a clock signal that is active during a serial communication phase and inactive during an idle phase, and the system clock is a clock signal that is continuously effective during both the serial communication phase and the idle phase. In the serial communication system, the serial communication device serves as a slave device, receiving data based on the communication clock or the system clock, and processing data based on the system clock.

The present application claims priority to a Chinese invention application No. 202310000676.X, filed on Jan. 3, 2023, entitled “SERIAL COMMUNICATION DEVICE, SERIAL COMMUNICATION SYSTEM, AND SERIAL COMMUNICATION METHOD,” the entire content of which is hereby incorporated by reference, including the entire specification, claims, drawings, and abstract.

### TECHNICAL FIELD

The present disclosure relates to a field of communication technology, in particular, to a serial communication device, a serial communication system, and a serial communication method based on dual clock signals.

### BACKGROUND

In electronic products, serial bus communication requires only a few interconnection lines and chip pins, occupying less circuit board area and providing better interconnection reliability. Therefore, serial bus communication is typically used in systems with limited pin resources, limited circuit board space, and cost sensitivity.

In serial communication, data is divided into individual binary bits and transmitted and received bit by bit according to a communication clock. A serial communication system includes a master device and a slave device. A line or a communication channel is used to achieve communication (data exchange) between the master device and the slave device. In the serial communication system, the communication channel between the master device and the slave device includes not only a data line but also a clock line. That is, the master device provides communication data D and a communication clock CLK to multiple slave devices. Typically, multiple slave devices shift the communication data D according to the communication clock CLK to obtain their respective received data and transmitted data.

In existing serial communication systems, the communication clock CLK provided by the master device is an intermittent pulse signal, which is enabled during a communication phase and disabled during an idle phase, mainly used for data reception and transmission. For example, an LED display system includes a control terminal and multiple LED driver circuits. The control terminal serves as a master device, and multiple LED driver circuits serve as multiple slave devices in the serial communication system. The control terminal is configured to send a communication clock and display data to the multiple LED driver circuits, which receive their respective display data based on the communication clock.

However, local functions of multiple slave devices in the serial communication system also require a continuous clock signal to achieve complex data processing and signal driving. For example, in the LED display system, the multiple LED driver circuits need a continuous clock signal (e.g., a local clock signal) to convert received display data into driving currents for LEDs in corresponding image areas, so as to achieve image display. If the multiple LED driver circuits in the LED display system each generate a local clock signal, there may be synchronization issues among the local clock signals of the multiple LED driver circuits, degrading the image quality of the entire image frame.

Therefore, it is still desired to further improve the serial communication system to balance clock requirements for local functions and data communication.

### SUMMARY OF THE DISCLOSURE

To solve the above technical problems, the present disclosure provides a serial communication device and a serial communication method. In a serial communication system, the serial communication device serves as a slave device, and is configured to receive data based on one of a communication clock and a system clock, and process data based on the system clock, thus balancing clock requirements for serial communication control and local data processing.

According to a first aspect of the present disclosure, a serial communication device is provided, and comprises: a first shift register for receiving data based on one of a communication clock and a system clock; a second shift register for transmitting data based on the system clock; and a data processing circuit for processing data based on the system clock, wherein the communication clock is a clock signal that is active during a serial communication phase and is inactive during an idle phase, and the system clock is a clock signal that is continuously effective during both the serial communication phase and the idle phase.

Optionally, when the serial communication device is the first-stage slave device in the serial communication system, the serial communication device is configured to receive the communication clock and the system clock.

Optionally, when the serial communication device is a subsequent-stage slave device after the first-stage slave device in the serial communication system, the serial communication device is configured to only receive the system clock.

Optionally, the serial communication device further comprises: a first clock input terminal for receiving a first clock signal, which is one of the communication clock and the system clock; a second clock input terminal for receiving a second clock signal or being coupled to a fixed voltage level, wherein the second clock signal is the system clock; a clock output terminal for transmitting the system clock; and a clock selection circuit for selecting the system clock according to a voltage level state at the second clock input terminal and providing the selected system clock to the second shift register and the data processing circuit, wherein the first shift register is coupled to the first clock input terminal to receive the first clock signal and receives data based on the first clock signal.

Optionally, in a case that the serial communication device is the first-stage slave device in the serial communication system, the first clock input terminal of the serial communication device is configured to receive the communication clock, and the second clock input terminal of the serial communication device is configured to receive the system clock.

Optionally, in a case that the serial communication device is a subsequent-stage slave device after the first-stage slave device in the serial communication system, the first clock input terminal of the serial communication device is configured to receive the system clock, and the second clock input terminal of the serial communication device is coupled to the fixed voltage level.

Optionally, the second clock input terminal of the serial communication device is grounded.

Optionally, in a case that the serial communication device is a last-stage slave device in the serial communication system, the clock output terminal and the data output terminal of the serial communication device are floating.

Optionally, the serial communication device further comprises: a clock processing circuit for processing the system clock before the system clock is transmitted.

Optionally, the serial communication device further comprises: a clock input terminal for receiving a first clock signal, which is one of the communication clock and the system clock; a clock output terminal for receiving a second clock signal or transmitting the first clock signal, wherein the second clock signal is the system clock; a clock transmission circuit for performing signal forwarding according to a pre-configured signal direction, thereby multiplexing the clock output terminal as one of an input terminal and an output terminal; and a clock selection circuit for selecting the system clock according to the signal direction of the clock transmission circuit and providing the selected system clock to the second shift register and the data processing circuit, wherein the first shift register is coupled to the clock input terminal to receive the first clock signal and is configured to receive data based on the first clock signal.

Optionally, the signal direction of the clock transmission circuit is configured by the serial communication device before serial communication.

Optionally, in a configuration phase before serial communication, the signal direction of the clock transmission circuit in the serial communication device is pre-configured as a signal receiving direction, and the serial communication device is configured to receive a configuration parameter and write the configuration parameter into the serial communication device.

Optionally, in the serial communication phase, the serial communication device is configured to read the configuration parameter and set the signal direction of the clock transmission circuit according to the configuration parameter.

Optionally, in a case that the serial communication device is the first-stage slave device in the serial communication system, the signal direction of the clock transmission circuit is a signal receiving direction.

Optionally, the clock input terminal of the serial communication device is configured to receive the communication clock, and the clock output terminal is configured to receive the system clock.

Optionally, in a case that the serial communication device is a subsequent-stage slave device after the first-stage slave device in the serial communication system, the signal direction of the clock transmission circuit is a signal output direction.

Optionally, the clock input terminal of the serial communication device is configured to receive the system clock, and the clock output terminal of the serial communication device is configured to transmit the system clock.

Optionally, in a case that the serial communication device is the last-stage slave device in the serial communication system, the clock output terminal and the data output terminal of the serial communication device are floating.

Optionally, the clock transmission circuit is configured to process the system clock before transmitting the system clock.

Optionally, the data processing circuit is configured to receive communication data from the first shift register, cache a portion of the communication data as received data, and send another portion of the communication data to the second shift register as transmitted data.

Optionally, the serial communication device is configured to forward the transmitted data during the serial communication phase and forward an idle identifier during the idle phase.

Optionally, the idle identifier is a continuous series of binary digits 0.

Optionally, the serial communication device is part of an LED driver circuit, the LED driver circuit is configured to receive display data based on one of the communication clock and the system clock, and during a frame cycle including continuous image frames, the LED driver circuit is configured to use the system clock to convert the display data into driving currents for LEDs in a corresponding image area.

According to a second aspect of the present disclosure, a serial communication system is provided, and comprises: a master device for providing communication data, a communication clock, and a system clock; and a plurality of slave devices, each including the above-mentioned serial communication device, wherein the plurality of slave devices are connected in series, and the first-stage slave device is coupled to the master device, and the plurality of slave devices are configured to receive data based on one of the communication clock and the system clock.

Optionally, the first-stage slave device in the plurality of slave devices is configured to receive data based on the communication clock, process and transmit data based on the system clock.

Optionally, the subsequent-stage slave device in the plurality of slave devices after the first-stage slave device is configured to receive, process and transmit data based on the system clock.

According to a third aspect of the present disclosure, a serial communication method is provided for data communication in a serial communication system comprising a master device and a plurality of slave devices, the serial communication method comprises: in the first-stage slave device in the plurality of slave devices, receiving data based on a communication clock, processing and transmitting data based on a system clock; and in subsequent-stage slave devices after the first-stage slave device in the plurality of slave devices, receiving, processing and transmitting data based on the system clock, wherein the communication clock is a clock signal that is active during a serial communication phase and inactive during an idle phase, and the system clock is a clock signal that is continuously effective during both the serial communication phase and the idle phase.

Optionally, the first clock input terminal of the first-stage slave device is configured to receive the communication clock, the second clock input terminal of the first-stage slave device is configured to receive the system clock, and the first-stage slave device is configured to select the system clock based on a voltage level state at the second clock input terminal and use the system clock for data processing and data transmission.

Optionally, the first clock input terminal of the subsequent-stage slave device is configured to receive the system clock, the second clock input terminal of the subsequent-stage slave device is coupled to a fixed voltage level, and the subsequent-stage slave device is configured to select the system clock based on a voltage level state at the second clock input terminal and use the system clock for data processing and data transmission.

Optionally, the clock transmission circuit of each of the plurality of slave devices is configured to set a signal direction based on a configuration parameter, thereby multiplexing the clock output terminal as one of an input terminal and an output terminal.

Optionally, the signal direction of the clock transmission circuit of the first-stage slave device is configured as a signal receiving direction, the clock input terminal of the first-stage slave device is configured to receive the communication clock, the clock output terminal of the first-stage slave device is configured to receive the system clock, the first-stage slave device is configured to select the system clock, and use the system clock for data processing and data transmission.

Optionally, the signal direction of the clock transmission circuit of the subsequent-stage slave device is configured as a signal output direction, the clock input terminal of the subsequent-stage slave device is configured to receive the system clock, the clock output terminal of the subsequent-stage slave device is configured to transmit the system clock, the subsequent-stage slave device is configured to select the system clock, and use the system clock for data processing and data transmission.

Optionally, the serial communication method further comprises, in a configuration phase before serial communication, pre-configuring a signal direction of the clock transmission circuit of each of the plurality of slave devices as a signal receiving direction, wherein the plurality of slave devices is configured to receive a configuration parameter and write the configuration parameter into the plurality of slave devices.

Optionally, in the serial communication phase, the plurality of slave devices are configured to read the configuration parameter and set the signal direction of the clock transmission circuit of each of the plurality of slave devices according to the configuration parameter.

Optionally, the plurality of slave devices are each configured to transmit data in the serial communication phase and transmit an idle identifier in the idle phase.

Optionally, the idle identifier is a continuous series of binary digits 0.

According to embodiments of the serial communication system of the present disclosure, the master device provides dual clock signals, wherein the communication clock CLK1 is an intermittent pulse signal, which is enabled during the communication phase and disabled during the idle phase, and the system clock CLK2 is a continuous pulse signal, which is always enabled during the entire system power-on phase. In the serial communication system, the serial communication device serves as a slave device, and is configured to receive data based on one of the communication clock and the system clock, and process data based on the system clock, so as to balance clock requirements for serial communication control and local data processing.

Furthermore, the first-stage slave device in the serial communication system receives dual clock signals, and the subsequent-stage slave devices each receive a single clock signal. The first-stage slave device is configured to receive data based on the communication clock, and the subsequent-stage slave devices is each configured to receive data based on the system clock. Therefore, communication between the first-stage slave device and the master device can be performed based on a standard serial communication protocol, while communication between the second-stage slave device and the subsequent-stage slave devices can be performed based on a custom serial communication protocol. Communication between the master device and the slave devices in the serial communication system is compatible with the standard serial communication protocol.

Furthermore, the first-stage slave device is configured to receive communication data based on the intermittent pulses of the communication clock, allowing the first-stage slave device to accurately determine a start time and an end time of serial communication. The first-stage slave device is configured to transmit the communication data to the subsequent-stage slave devices during the serial communication phase and transmit an idle identifier during the idle phase, allowing the subsequent-stage slave devices to accurately determine the start time and the end time of serial communication based on the content of the communication data. Optionally, internal structures of the first-stage slave device and the subsequent-stage slave devices may be the same, but pin connections may be different. The multiple slave devices in the serial communication system can each identify whether it serves as the first-stage slave device based on the pin connections. Therefore, an operating mode of multiple slave devices can be configured using hardware method by changing the pin connections.

Furthermore, the master device of the serial communication system provides a continuous operating clock for multiple slave devices, simplifying the local clock circuits of multiple slave devices. Since the operating clocks of multiple slave devices in the serial communication system originate from the same clock signal, the system clock can be used to maintain timing consistency among the operating clocks, simplifying or even eliminating the clock synchronization circuits of the multiple slave devices.

The system clock received by the multiple slave devices in the serial communication system is a continuous clock signal, allowing the multiple slave devices to use the system clock as an operating clock to achieve complex functions. For example, in an LED display system, an LED driver circuit can use the continuous clock signal of the system clock as the operating clock for local data processing, converting display data into driving currents for LEDs in a corresponding image area during the entire frame cycle of an image frame, so as to achieve image display. Therefore, the serial communication system using dual clock signals can balance clock requirements for serial communication control and local data processing.

### BRIEF DESCRIPTION OF THE DRAWINGS

The above and other objectives, features, and advantages of the present disclosure will become more apparent from the following description of the embodiments of the present disclosure with reference to the accompanying drawings.

FIG. 1 shows a schematic block diagram of a serial communication system according to the prior art.

FIGS. 2 and 3 respectively show schematic block diagrams of the master device and slave devices in the serial communication system shown in FIG. 1.

FIG. 4 shows a schematic block diagram of a serial communication system according to a first embodiment of the present disclosure.

FIG. 5 shows a schematic block diagram of the master device in the serial communication system shown in FIG. 4.

FIGS. 6a and 6b respectively show schematic block diagrams of the first-stage slave device and a second-stage slave device in the serial communication system shown in FIG. 4.

FIG. 7 shows a working sequence diagram of the serial communication system shown in FIG. 4.

FIG. 8 shows a flowchart of a serial communication method for slave devices in the serial communication system shown in FIG. 4.

FIG. 9 shows a schematic block diagram of a serial communication system according to a second embodiment of the present disclosure.

FIG. 10 shows a schematic block diagram of the master device in the serial communication system shown in FIG. 9.

FIGS. 11a and 11b respectively show schematic block diagrams of the first-stage slave device and the second-stage slave device in the serial communication system shown in FIG. 9.

FIG. 12 shows a flowchart of a serial communication method for slave devices in the serial communication system shown in FIG. 9.

### DETAILED DESCRIPTION

To facilitate understanding of the present disclosure, a more comprehensive description of the present disclosure will be provided below with reference to the relevant drawings. The preferred embodiments of the present disclosure are given in the drawings. However, the present disclosure can be implemented in different forms and is not limited to the embodiments described herein. Rather, the purpose of providing these embodiments is to make the understanding of the disclosure of the present disclosure more thorough and comprehensive.

In this application, the term “first-stage slave device” refers to a slave device directly connected to a master device in a serial communication system, “second-stage slave device” refers to a slave device directly connected to the first-stage slave device in the serial communication system, and “subsequent-stage slave device” refers to any subsequent-stage slave device directly or indirectly connected after a specific slave device in the serial communication system.

Unless otherwise defined, all technical and scientific terms used herein have the same meanings as commonly understood by those skilled in the art to which the present disclosure belongs. The terms used in the specification of the present disclosure are for the purpose of describing specific embodiments only and are not intended to limit the present disclosure.

It should be understood that, the steps in the flowcharts of the present disclosure are sequentially displayed according to the direction of the arrows, but these steps are not necessarily executed in the order indicated by the arrows. Unless explicitly stated herein, there is no strict order restriction on the execution of these steps, and these steps can be executed in other orders. Moreover, at least some of the steps in the figures may include multiple sub-steps or multiple stages, and these sub-steps or stages are not necessarily executed at the same time but can be executed at different times. The execution order of these sub-steps or stages is not necessarily sequential but can be executed alternately or in rotation with at least some of the sub-steps or stages of other steps.

The present disclosure will be described in detail below with reference to the accompanying drawings.

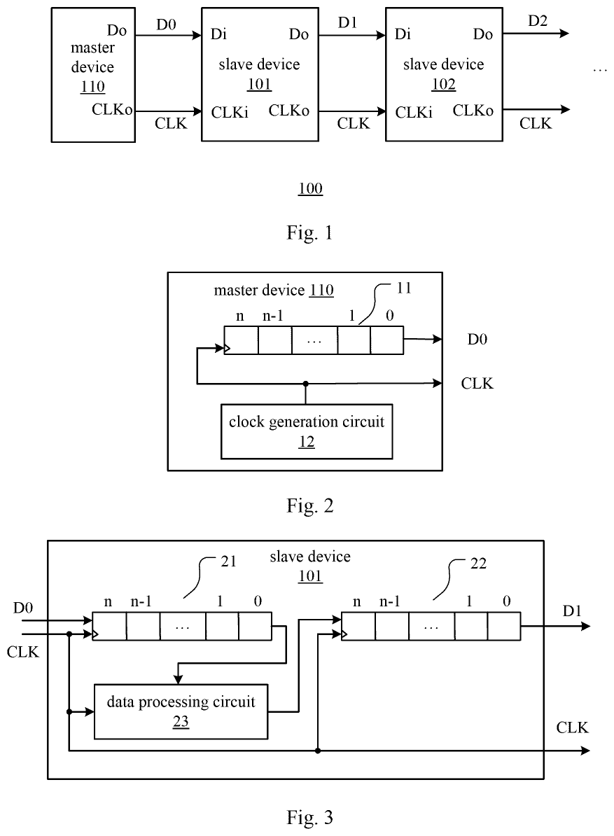

FIG. 1 shows a schematic block diagram of a serial communication system according to the prior art, and FIGS. 2 and 3 respectively show schematic block diagrams of a master device and slave devices in the serial communication system. The serial communication system 100 includes a master device 110 and slave devices 101 and 102 connected in series. In the present disclosure, only the first-stage slave device and the second-stage slave device are shown for clarity, but it can be understood that the number of slave devices is not limited to 2 and can be any number.

The master device 110 includes a data output terminal Do and a clock output terminal CLKo, for providing communication data D and a communication clock CLK, respectively. Each of the slave devices 101 and 102 includes a data input terminal Di and a data output terminal Do, as well as a clock input terminal CLKi and a clock output terminal CLKo. The data input terminal Di of the slave device 101 is connected to the data output terminal Do of the master device 110 to receive communication data D0, and the data output terminal Do of the slave device 101 is connected to the data input terminal Di of a subsequent-stage slave device. The clock input terminal CLKi of the slave device 101 is connected to the clock output terminal CLKo of the master device 110 to receive the communication clock CLK, and the clock output terminal CLKo of the slave device 101 is connected to the clock input terminal CLKi of the subsequent-stage slave device.

The master device 101 includes a shift register 11 and a clock generation circuit 12. The clock generation circuit 12 is configured to generate the communication clock CLK. The shift register 11 is configured to shift the communication data D0 according to the timing of the communication clock CLK and transmit the communication data D0 bit by bit to the slave devices. For example, the shift register 11 is configured to transmit one bit of the communication data D0 in each clock cycle of the communication clock CLK.

The slave device 101 includes shift registers 21 and 22 and a data processing circuit 23. The slave device 101 is configured to receive the communication data D0 and the communication clock CLK. The shift register 21 is configured to shift the communication data D0 according to the timing of the communication clock CLK to receive the communication data D0 bit by bit. For example, the shift register 21 is configured to receive one bit of the communication data D0 in each clock cycle of the communication clock CLK. The data processing circuit 23 is configured to cache a portion of the communication data D0 as its own received data and send another portion of the communication data D0 to the shift register 22 as its own transmitted data. The transmitted data of the slave device 101 is the received data D1 of all subsequent-stage slave devices. The shift register 22 is configured to shift the communication data D1 according to the timing of the communication clock CLK and transmit the communication data D1 bit by bit to the slave devices. For example, the shift register 22 is configured to transmit one bit of the communication data D1 in each clock cycle of the communication clock CLK.

The internal structure and data communication of the slave devices 102 are similar to those of the slave device 101 and will not be described in detail here. The multiple slave devices in the serial communication system 100 sequentially obtain their own received data and forward data to the subsequent-stage slave devices in a manner similar to that of the slave device 101, thereby sequentially transmitting the communication data D0 of the master device 110 to the multiple slave devices connected in series.

In the above-mentioned prior art serial communication system, the communication clock CLK provided by the master device is an intermittent pulse signal, which is enabled during the communication phase and disabled during the idle phase, and is mainly used for data reception and transmission. However, local functions of the multiple slave devices may also require a continuous clock signal for achieving complex functions. In a case where the multiple slave devices achieve complex functions, the multiple slave devices can use a local clock generation circuit to provide a continuous clock signal. However, timing differences are likely to occur among the multiple slave devices, synchronizing the local clock circuits of the multiple slave devices will lead to further increased circuit costs.

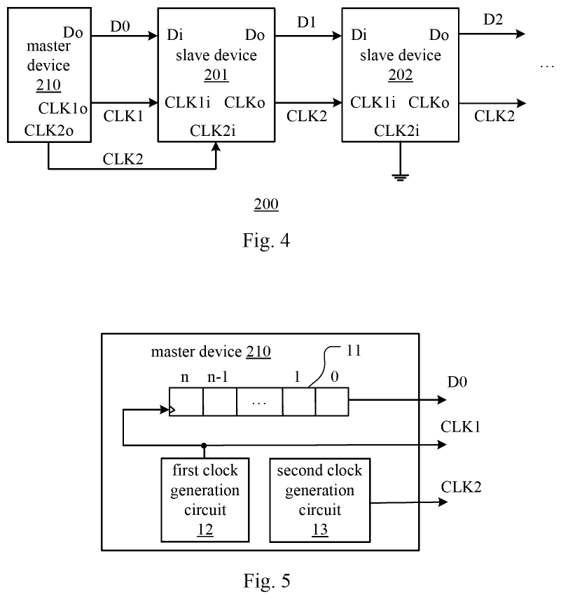

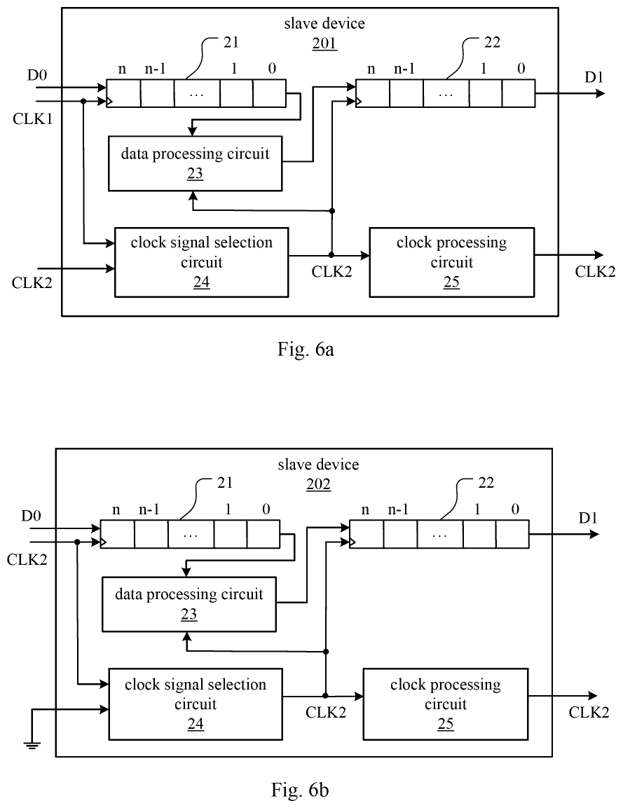

FIG. 4 shows a schematic block diagram of a serial communication system according to a first embodiment of the present disclosure, FIG. 5 shows a schematic block diagram of a master device in the serial communication system shown in FIG. 4, and FIGS. 6a and 6b respectively show schematic block diagrams of the first-stage slave device and a second-stage slave device in the serial communication system shown in FIG. 4. The serial communication system 200 includes the first-stage slave device 201 and second-stage slave device 202 connected in series, and a master device 210. In the present disclosure, only the first-stage slave device and the second-stage slave device are shown for clarity, but it can be understood that the number of slave devices is not limited to 2 and can be any number.

The master device 210 includes a data output terminal Do, a first clock output terminal CLK1o, and a second clock output terminal CLK2o, for providing communication data D0, a communication clock CLK1, and a system clock CLK2, respectively. Each of the first-stage slave device 201 and the second-stage slave device 202 includes a data input terminal Di and a data output terminal Do, as well as a first clock input terminal CLK1i, a second clock input terminal CLK2i, and a clock output terminal CLKo.

The data input terminal Di of the first-stage slave device 201 is connected to the data output terminal Do of the master device 210 to receive the communication data D0, and the data output terminal Do of the first-stage slave device 201 is connected to the data input terminal Di of a subsequent-stage slave device. The first clock input terminal CLK1i of the first-stage slave device 201 is connected to the first clock output terminal CLK1o of the master device 210 to receive the communication clock CLK1, the second clock input terminal CLK2i of the first-stage slave device 201 is connected to the second clock output terminal CLK2o of the master device 210 to receive the system clock CLK2, and the clock output terminal CLKo of the first-stage slave device 201 is connected to the first clock input terminal CLK1i of the subsequent-stage slave device.

The data input terminal Di of the second-stage slave device 202 is connected to the data output terminal Do of the first-stage slave device 201 to receive the communication data D1, and the data output terminal Do of the second-stage slave device 202 is connected to the data input terminal Di of a subsequent-stage slave device. The first clock input terminal CLK1i of the second-stage slave device 202 is connected to the clock output terminal CLKo of the first-stage slave device 201 to receive the system clock CLK2, and the second clock input terminal CLK2i of the second-stage slave device 202 is connected to a fixed voltage level, for example, the second clock input terminal CLK2i of the second-stage slave device 202 is grounded, and the clock output terminal CLKo of the second-stage slave device 202 is connected to the first clock input terminal CLK1i of the subsequent-stage slave device.

The master device 210 includes a shift register 11, a first clock generation circuit 12, and a second clock generation circuit 13. In a preferred embodiment, the master device 210 includes a microcontroller unit (MCU) and an oscillator. The MCU is used to execute program code to implement the shift function of the shift register 11 and the clock signal generation function of the first clock generation circuit 12, and the oscillator is used to implement the clock signal generation function of the second clock generation circuit 13.

The first clock generation circuit 12 is configured to generate the communication clock CLK1, and the second clock generation circuit 13 is configured to generate the system clock CLK2. Optionally, the communication clock CLK1 is a clock signal synchronized with the system clock CLK2. Furthermore, the communication clock CLK1 is an intermittent clock signal, which is enabled during the communication phase and disabled during the idle phase, while the system clock CLK2 is a continuous clock signal, which is always enabled during the entire system power-on phase. The shift register 11 is configured to shift the communication data D0 according to the timing of the communication clock CLK1 and transmit the communication data D0 bit by bit to the slave devices. For example, the shift register 11 is configured to transmit one bit of the communication data D0 in each clock cycle of the communication clock CLK1.

The first-stage slave device 201 includes multiple logic circuit units, that is, the shift registers 21 and 22, a data processing circuit 23, and a clock selection circuit 24. The first-stage slave device 201 is configured to receive the communication data D0, the communication clock CLK1, and the system clock CLK2.

An operating clock of the shift register 21 is the communication clock CLK1. The clock signal selection circuit 24 is configured to select a clock signal as an operating clock for the shift register 22 and the data processing circuit 23 according to a voltage level state at the second clock input terminal CLK2i. Referring to FIG. 4, the second clock input terminal CLK2i of the first-stage slave device 201 is connected to the second clock output terminal CLK2o of the master device, so the clock signal selection circuit 24 can always receive the continuous pulse signal of the system clock CLK2. Therefore, the first-stage slave device 201 always selects the system clock CLK2 as the operating clock for the shift register 22 and the data processing circuit 23.

The shift register 21 is configured to shift the communication data D0 according to the timing of the communication clock CLK1 to receive the communication data D0 bit by bit. For example, the shift register 21 is configured to receive one bit of the communication data D0 in each clock cycle of the communication clock CLK1. The data processing circuit 23 is configured to cache a portion of the communication data D0 as its own received data and send another portion of the communication data D0 to the shift register 22 as its own transmitted data. In a typical case, the transmitted data of the first-stage slave device 201 is the received data D1 of all subsequent-stage slave devices. The shift register 22 is configured to shift the communication data D1 according to the timing of the system clock CLK2 and transmit the communication data D1 bit by bit to a next-stage slave device. For example, the shift register 22 is configured to transmit one bit of the communication data D1 in each clock cycle of the communication clock CLK1.

Optionally, the first-stage slave device 201 further includes a clock processing circuit 25 for processing the system clock CLK2 before the system clock CLK2 is forwarded. For example, the clock processing circuit 25 includes a buffer and a delay compensation circuit for improving driving capability. The first-stage slave device 201 is configured to forward the system clock CLK2 to a subsequent-stage slave device via the clock output terminal CLKo.

An internal structure of the second-stage slave device 202 can be the same as that of the first-stage slave device 201, but the pin connections may be different. The first clock input terminal CLK1i of the second-stage slave device 202 is connected to the clock output terminal CLKo of the first-stage slave device 201, and the second clock input terminal CLK2i of the second-stage slave device 202 is connected to a fixed voltage level, for example, the second clock input terminal CLK2i of the second-stage slave device 202 is grounded. The clock signal provided by the clock output terminal CLKo of the first-stage slave device 201 is the system clock CLK2, so the first clock input terminal CLK1i of the second-stage slave device 202 is configured to receive the system clock CLK2.

In the second-stage slave device 202, an operating clock of the shift register 21 is the system clock CLK2. The clock signal selection circuit 24 is configured to select a clock signal as the operating clock for the shift register 22 and the data processing circuit 23 according to a voltage level state at the second clock input terminal CLK2i. Referring to FIG. 4, the second clock input terminal CLK2i of the second-stage slave device 202 is grounded, so the clock signal selection circuit 24 always selects the system clock CLK2 received at the first clock input terminal CLK1i. Therefore, the operating clocks of the shift register 21, the shift register 22, and the data processing circuit 23 of the second-stage slave device 202 are all the system clock CLK2.

In the serial communication system 200, starting from the second-stage slave device, the second clock input terminal of each slave device is grounded, and the data output terminal Do and the clock output terminal CLKo of the last-stage slave device are floating. Although not shown in the figure, an internal structure of each slave device in the serial communication system 200 is similar to that of the first-stage slave device 201 and will not be described in detail here. The multiple slave devices in the serial communication system 200 sequentially obtain their own received data and forward data to a subsequent-stage slave device in a manner similar to that of the first-stage slave device 201 and the second-stage slave device 202, thereby sequentially transmitting the communication data D0 of the master device 210 to the multiple slave devices connected in series.

According to an embodiment of the serial communication system of the present disclosure, the master device provides dual clock signals, wherein the communication clock CLK1 is an intermittent pulse signal, which is enabled during the communication phase and disabled during the idle phase, and the system clock CLK2 is a continuous pulse signal, which is always enabled during the entire system power-on phase. In the serial communication system, the serial communication device serves as a slave device, and is configured to receive data based on one of the communication clock and the system clock, and process data based on the system clock, so as to balance clock requirements for serial communication control and local data processing.

Furthermore, the first-stage slave device in the serial communication system receives dual clock signals, and the subsequent-stage slave devices each receive a single clock signal. The first-stage slave device is configured to receive data based on the communication clock, and the subsequent-stage slave devices is each configured to receive data based on the system clock. Therefore, communication between the first-stage slave device and the master device can be performed based on a standard serial communication protocol, while communication between the second-stage slave device and a subsequent-stage slave device can be performed based on a custom serial communication protocol. Communication between the master device and the slave devices in the serial communication system is compatible with the standard serial communication protocol.

Furthermore, the first-stage slave device is configured to receive communication data based on the intermittent pulses of the communication clock, allowing the first-stage slave device to accurately determine a start time and an end time of serial communication. The first-stage slave device is configured to transmit the communication data to a subsequent-stage slave devices during the serial communication phase and transmit an idle identifier during the idle phase, allowing the subsequent-stage slave device to accurately determine the start time and the end time of serial communication based on the content of the communication data. Optionally, internal structures of the first-stage slave device and the subsequent-stage slave devices may be the same, but pin connections may be different. The multiple slave devices in the serial communication system can each identify whether it serves as the first-stage slave device based on the pin connections. Therefore, an operating mode of each of the multiple slave devices can be configured using hardware by changing the pin connections.

Furthermore, the master device of the serial communication system provides a continuous operating clock for multiple slave devices, simplifying the local clock circuits of multiple slave devices. Since the operating clocks of multiple slave devices in the serial communication system originate from the same clock signal, the system clock can be used to maintain timing consistency among them, simplifying or even eliminating the clock synchronization circuits of the multiple slave devices.

The system clock received by the multiple slave devices in the serial communication system is a continuous clock signal, allowing the multiple slave devices to use the system clock as an operating clock to achieve complex functions. For example, in an LED display system, the LED driver circuit can use the continuous clock signal of the system clock as the operating clock for local data processing, converting display data into driving currents for LEDs in a corresponding image area during the entire frame cycle of an image frame, so as to achieve image display. Therefore, the serial communication system uses dual clock signals can balance clock requirements for serial communication control and local data processing.

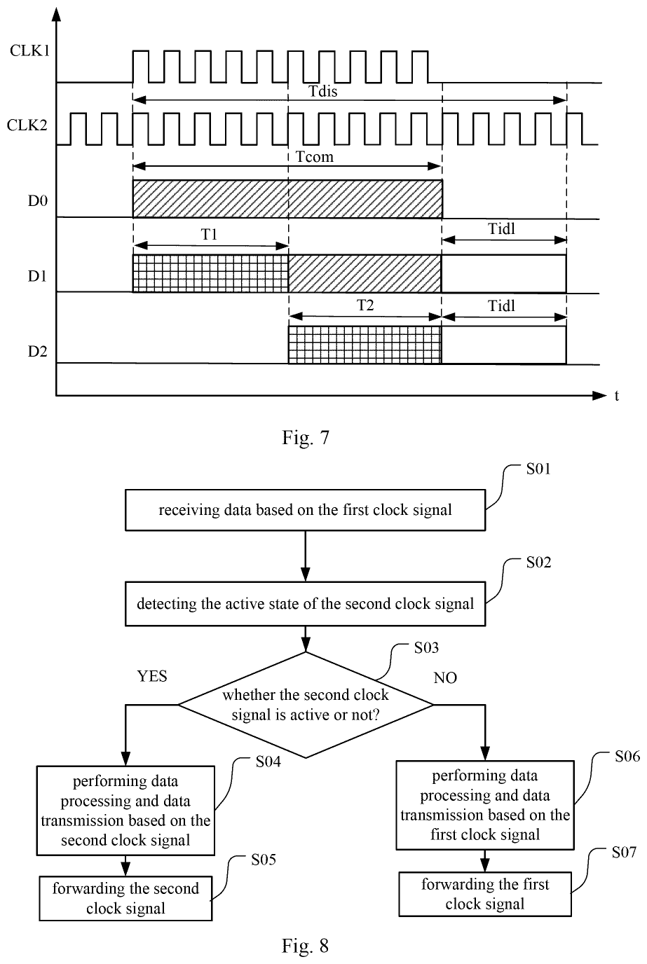

FIG. 7 shows a working sequence diagram of the serial communication system shown in FIG. 4. In the serial communication system, multiple slave devices are connected in series, the first-stage slave device 201 is connected to the master device 210 to receive the data signal D0, the communication clock CLK1, and the system clock CLK2, and the subsequent-stage slave devices are each connected to a preceding-stage slave device to receive the system clock CLK2 and a corresponding transmitted data Di from the preceding-stage slave device, where i represents an integer greater than 1.

In the serial communication phase, the master device 210 is configured to provide the communication data to the shift register 11 and transmit data D0 bit by bit according to the clock cycle of the communication clock CLK1. The data of multiple slave devices can be continuously transmitted. In a case where the bit length of the data D0 is greater than the bit length of the shift register 11, the data D0 can be divided into words corresponding to the bit length of the shift register 11, provided to the shift register 11 word by word, and then transmitted bit by bit to the first-stage slave device 201 by the shift register 11.

In the serial communication phase, the first-stage slave device 201 can accurately determine the start time and the end time of serial communication based on the active state of the communication clock CLK1. Specifically, the operating clock of the shift register 21 of the first-stage slave device 201 is the communication clock CLK1, so the shift register 21 of the first-stage slave device 201 operates synchronously with the shift register 11 of the master device 210. As the shift register 11 of the master device 210 is cleared bit by bit, the shift register 21 of the first-stage slave device 201 is filled bit by bit. The shift register 11 of the master device 210 repeats filling and clearing, thus enabling the transmission of data of any bit length, and correspondingly, the first-stage slave device 201 can synchronously receive data of any bit length.

Furthermore, the first-stage slave device 201 obtains a predetermined bit length of data (i.e., a corresponding number of clock pulses corresponding to a predetermined time period T1) from the data D0 as received data, and then uses the remaining bits (data D1) as its own transmitted data.

As described above, the first-stage slave device 201 can accurately determine the start time and the end time of serial communication based on the active state of the communication clock CLK1. The first-stage slave device 201 sends communication data to a subsequent-stage slave device during the serial communication phase and sends an idle identifier during the idle phase, allowing the subsequent-stage slave device to accurately determine the start time and the end time of serial communication based on the content of the communication data. Optionally, the idle identifier sent by the first-stage slave device is a continuous series of binary digits 0. Therefore, during the idle phase of serial communication, the first-stage slave device 201 sets all bit data of the shift register 22 to 0, and the subsequent-stage slave device can determine the idle phase of serial communication based on the continuous bit data 0, thereby performing corresponding data processing.

The second-stage slave device 202 is configured to receive data based on the system clock CLK2. Due to the characteristic that the system clock CLK2 has continuous pulses, the second-stage slave device 202 is always operated under data communication state during the power-on period of the serial communication system.

Furthermore, the shift register of the second-stage slave device 202 operates synchronously with the shift register of the first-stage slave device 201 based on the system clock CLK2, thereby receiving the communication data. The second-stage slave device 202 can accurately determine the start time and the end time of serial communication based on the content of the communication data. In the serial communication phase, the second-stage slave device 202 obtains a predetermined bit length of data (i.e., a corresponding number of clock pulses corresponding to a predetermined time period T2) from the data D1 as received data, and then uses the remaining bits (data D2) as its own transmitted data.

In an LED display system, the entire frame cycle Tdis of an image frame includes at least a predetermined time period serving as the serial communication period Tcom, and the remaining clock period serving as the idle period Tidl. Multiple LED driver circuits in the LED display system receive their respective display data during the serial communication period Tcom, stop receiving their respective display data during the idle period Tidl, and during the entire frame cycle Tdis, convert the display data into driving currents for LEDs in a corresponding image area based on the system clock CLK2 to achieve image display.

Therefore, the multiple LED driver circuits in the LED display system can receive display data from the control terminal based on a standard serial communication protocol and can each receive display data from a preceding-stage LED driver circuit based on a custom serial communication protocol. The custom serial communication protocol is configured to receive and transmit data based on continuous clock pulses. The multiple LED driver circuits in the LED display system use continuous clock signals of the system clock as the operating clock for local data processing to achieve complex functions.

FIG. 8 shows a flowchart of a serial communication method for slave devices in the serial communication system shown in FIG. 4. The multiple slave devices in the serial communication system 200, no matter the first-stage slave device or a subsequent-stage slave device after the first-stage slave device, each execute the serial communication method shown in FIG. 8.

The following detailed description is provided by taking the first-stage slave device 201 and the second-stage slave device 202 as examples.

The first-stage slave device 201 is connected to the master device 210 to receive a data signal D0, a communication clock CLK1, and a system clock CLK2. The first-stage slave device 201 receives the communication clock CLK1 as a first clock signal via the first clock input terminal CLK1i and receives the system clock CLK2 as a second clock signal via the second clock input terminal CLK2i.

The second-stage slave device 202 is connected to the first-stage slave device 201 to receive a data signal D1 and is connected to the master device 201 to receive the system clock CLK2. The second-stage slave device 202 receives a single clock signal via the first clock input terminal CLK1i, the second clock input terminal CLK2i is connected to a fixed voltage level. It should be noted that, unlike the first-stage slave device 201, the first clock signal received by the second-stage slave device 202 is already converted into the system clock CLK2.

In step S01, the first-stage slave device 201 and the second-stage slave device 202 respectively receive data based on the first clock signal.

The shift register 21 in the first-stage slave device 201 is coupled to the first clock input terminal CLK1i to receive the communication clock CLK1, so the operating clock of the shift register 21 is the communication clock CLK1. The shift register 21 shifts the communication data D0 according to the timing of the communication clock CLK1 to receive the communication data D0 bit by bit. For example, the shift register 21 receives one bit of the communication data D0 in each clock cycle of the communication clock CLK1.

The shift register 21 in the second-stage slave device 202 is coupled to the first clock input terminal CLK1i to receive the system clock CLK2, so the operating clock of the shift register 21 is the system clock CLK2. The shift register 21 shifts the communication data D1 according to the timing of the system clock CLK2 to receive the communication data D1 bit by bit. For example, the shift register 21 receives one bit of the communication data D1 in each clock cycle of the system clock CLK2.

In step S02, the first-stage slave device 201 and the second-stage slave device 202 are respectively configured to detect the active state of the second clock signal.

In the serial communication system 200, the clock selection circuit 24 of each of the multiple slave devices is coupled to the first clock input terminal CLK1i to receive the first clock signal and is coupled to the second clock input terminal CLK2i to receive the second clock signal. The clock selection circuit 24 is configured to determine whether the second clock signal is active based on a voltage level state at the second clock input terminal CLK2i.

In step S03, the first-stage slave device 201 and the second-stage slave device 202 are respectively configured to determine whether the second clock signal is active.

If the clock selection circuit 24 of the first-stage slave device 201 detects that the second clock input terminal CLK2i receives continuous clock pulses, the clock selection circuit 24 of the first-stage slave device 201 confirms that the second clock signal is active. Therefore, the first-stage slave device 201 continues to execute steps S04 and S05.

In step S04, the first-stage slave device 201 selects the second clock signal as an operating clock for data processing and data transmission.

The first-stage slave device 201 receives the communication clock CLK1 and the system clock CLK2 as the first clock signal and the second clock signal, respectively. The second clock input terminal CLK2i of the first-stage slave device 201 always receives the system clock CLK2 during the system power-on phase. In a case that the second clock signal is detected to be active, the operating clock selected by the clock selection circuit 24 is the system clock CLK2. Therefore, the operating clock used for data reception in the first-stage slave device 201 is the communication clock CLK1, but the operating clock used for data processing and data transmission is the system clock CLK2.

In step S05, the first-stage slave device 201 transmits the second clock signal to a subsequent-stage slave device. Since the first-stage slave device 201 selects the system clock CLK2 as the second clock signal, the first clock signal received by the first clock input terminal CLK1i of the second-stage slave device 202 is already converted into the system clock CLK2.

The clock selection circuit 24 of the second-stage slave device 202 detects that the second clock input terminal CLK2i is connected to a fixed voltage level, for example, the second clock input terminal CLK2i is grounded. The clock selection circuit 24 of the second-stage slave device 202 confirms that the second clock signal is inactive, so the second-stage slave device 202 continues to execute steps S06 and S07.

In step S06, the second-stage slave device 202 selects the first clock signal as the operating clock for data processing and data transmission.

As described above, the first clock signal received by the second-stage slave device 202 is the system clock CLK2. The second clock input terminal CLK2i of the second-stage slave device is always connected to a fixed voltage level during the system power-on phase. In a case that the second clock signal is detected to be inactive, the operating clock selected by the clock selection circuit 24 is the first clock signal, i.e., the system clock CLK2. Therefore, the operating clocks for data reception, data processing, and data transmission in the second-stage slave device 202 are all the system clock CLK2.

In step S07, the second-stage slave device 202 transmits the first clock signal to a subsequent-stage slave device. Since the second-stage slave device selects the system clock CLK2 as the first clock signal, the first clock signal received by the first clock input terminal CLK1i of the subsequent-stage slave device is already converted into the system clock CLK2.

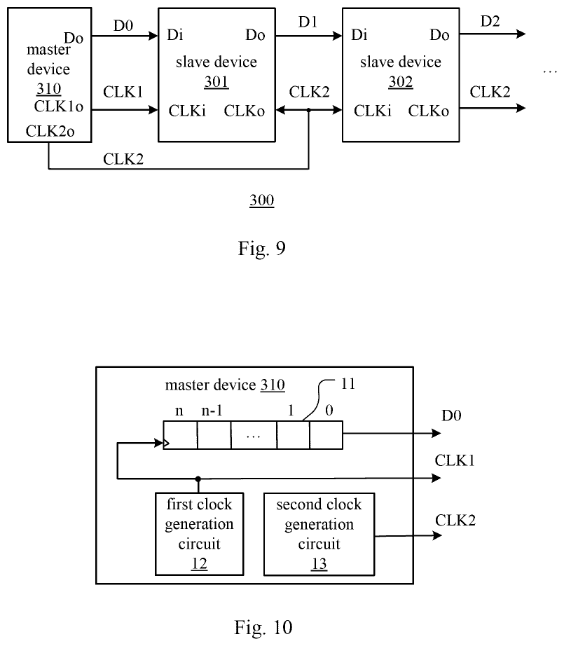

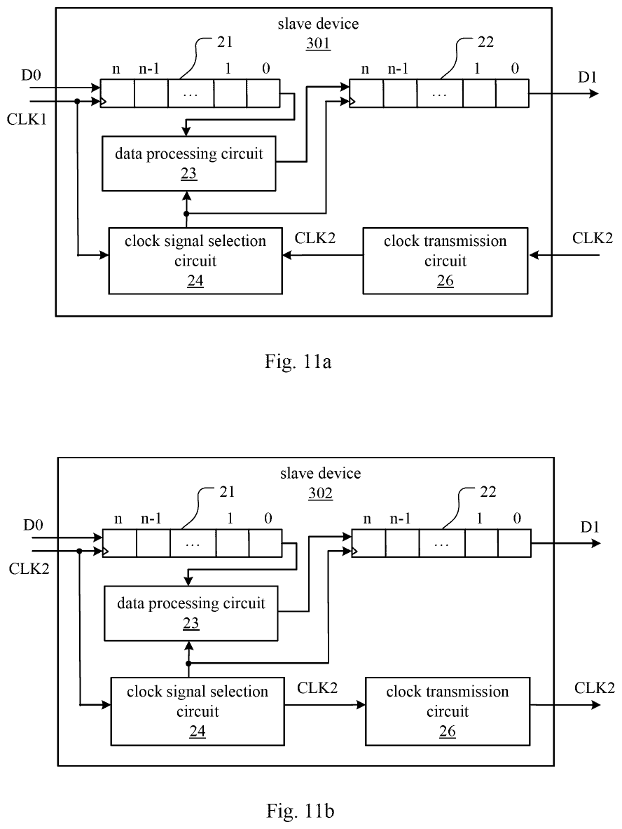

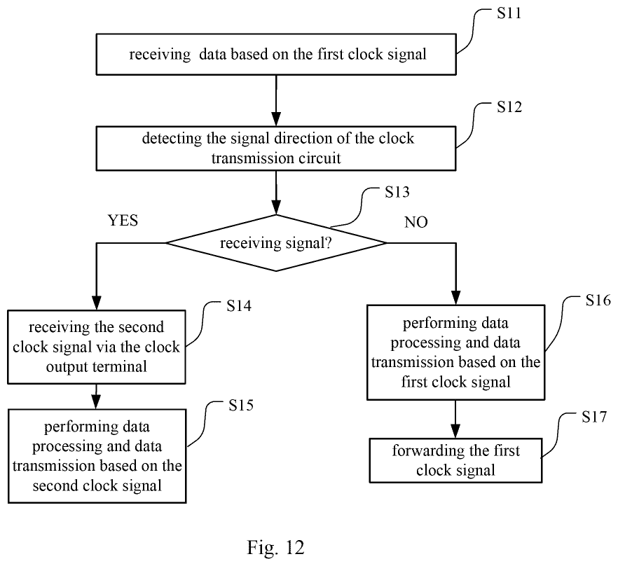

FIG. 9 shows a schematic block diagram of a serial communication system according to a second embodiment of the present disclosure, FIG. 10 shows a schematic block diagram of the master device in the serial communication system shown in FIG. 9, and FIGS. 11a and 11b respectively show schematic block diagrams of the first-stage slave device and a second-stage slave device in the serial communication system shown in FIG. 9. The serial communication system 300 includes the first-stage slave device 301 and the second-stage slave device 302 connected in series, and a master device 310. In the present disclosure, only the first-stage slave device and the second-stage slave device are shown for clarity, but it can be understood that the number of slave devices is not limited to 2 and can be any number.

The master device 310 includes a data output terminal Do, a first clock output terminal CLK1o, and a second clock output terminal CLK2o, for providing communication data D0, a communication clock CLK1, and a system clock CLK2, respectively. Each of the first-stage slave device 301 and the second-stage slave device 302 includes a data input terminal Di and a data output terminal Do, as well as a clock input terminal CLKi and a clock output terminal CLKo.

The data input terminal Di of the first-stage slave device 301 is connected to the data output terminal Do of the master device 310 to receive the communication data D0, and the data output terminal Do of the first-stage slave device 301 is connected to the data input terminal Di of a subsequent-stage slave device. The clock input terminal CLKi of the first-stage slave device 301 is connected to the first clock output terminal CLK1o of the master device 310 to receive the communication clock CLK1, the clock output terminal CLKo of the first-stage slave device 301 is connected to the second clock output terminal CLK2o of the master device 310 to receive the system clock CLK2, and the clock output terminal CLKo of the first-stage slave device 301 is connected to the clock input terminal CLKi of the subsequent-stage slave device.

The data input terminal Di of the second-stage slave device 302 is connected to the data output terminal Do of the first-stage slave device 301 to receive the communication data D1, and the data output terminal Do of the second-stage slave device 302 is connected to the data input terminal Di of a subsequent-stage slave device. The clock input terminal CLKi of the second-stage slave device 302 is connected to the clock output terminal CLKo of the first-stage slave device 301 to receive the system clock CLK2, and the clock output terminal CLKo of the second-stage slave device 302 is connected to the clock input terminal CLKi of the subsequent-stage slave device.

The master device 310 includes a shift register 11, a first clock generation circuit 12, and a second clock generation circuit 13. In a preferred embodiment, the master device 310 includes a microcontroller unit (MCU) and an oscillator. The MCU is used to execute program code to implement the shift function of the shift register 11 and the clock signal generation function of the first clock generation circuit 12, and the oscillator is used to implement the clock signal generation function of the second clock generation circuit 13.

The first clock generation circuit 12 generates the communication clock CLK1, and the second clock generation circuit 13 generates the system clock CLK2. Optionally, the communication clock CLK1 is a clock signal synchronized with the system clock CLK2. Furthermore, the communication clock CLK1 is an intermittent clock signal, which is enabled during the communication phase and disabled during the idle phase, while the system clock CLK2 is a continuous clock signal, which is always enabled during the entire system power-on phase. The shift register 11 shifts the communication data D0 according to the timing of the communication clock CLK1 and transmits the communication data D0 bit by bit to the slave device. For example, the shift register 11 transmits one bit of the communication data D0 in each clock cycle of the communication clock CLK1.

The first-stage slave device 301 includes multiple logic circuit units, that is, shift registers 21 and 22, a data processing circuit 23, a clock selection circuit 24, and a clock transmission circuit 26. The first-stage slave device 301 receives the communication data D0, the communication clock CLK1, and the system clock CLK2.

The operating clock of the shift register 21 is the communication clock CLK1. The clock signal selection circuit 24 selects a clock signal based on a signal direction of the clock transmission circuit 26 as the operating clock for the shift register 22 and the data processing circuit 23. Referring to FIG. 9, the clock output terminal CLKo of the first-stage slave device 301 is connected to the second clock output terminal CLK2o of the master device, and the signal direction of the clock transmission circuit 26 of the first-stage slave device 301 is a signal receiving direction. Therefore, the first-stage slave device 301 receives the communication clock CLK1 as the first clock signal via the clock input terminal CLKi, and receives the system clock CLK2 as the second clock signal via the clock output terminal CLKo. The first-stage slave device 301 selects the second clock signal (i.e., the system clock CLK2) as the operating clock for the shift register 22 and the data processing circuit 23 according to the signal direction of the clock transmission circuit 26.

The shift register 21 shifts the communication data D0 according to the timing of the communication clock CLK1 to receive the communication data D0 bit by bit. For example, the shift register 21 receives one bit of the communication data D0 in each clock cycle of the communication clock CLK1. The data processing circuit 23 caches a portion of the communication data D0 as its own received data and sends another portion of the communication data D0 to the shift register 22 as its own transmitted data. In a typical case, the transmitted data of the first-stage slave device 301 is the received data D1 of all subsequent-stage slave devices. The shift register 22 shifts the communication data D1 according to the timing of the system clock CLK2 and transmits the communication data D1 bit by bit to a next-stage slave device. For example, the shift register 22 transmits one bit of the communication data D1 in each clock cycle of the communication clock CLK1.

An internal structure of the second-stage slave device 302 is the same as that of the first-stage slave device 301, but pin connections may be different. The clock input terminal CLKi of the second-stage slave device 302 is connected to the clock output terminal CLKo of the first-stage slave device 301, so the clock input terminal CLKi of the second-stage slave device 302 receives the system clock CLK2.

In the second-stage slave device 302, the operating clock of the shift register 21 is the system clock CLK2. The clock signal selection circuit 24 selects a clock signal as the operating clock for the shift register 22 and the data processing circuit 23, according to the signal direction of the clock transmission circuit 26. Referring to FIG. 9, the clock input terminal CLKi of the second-stage slave device 302 is connected to the clock output terminal CLKo of the first-stage slave device 301 to receive the system clock CLK2, and the signal direction of the clock transmission circuit 26 of the second-stage slave device 302 is a signal output direction. Therefore, the clock signal selection circuit 24 always selects the system clock CLK2 received at the clock input terminal CLKi. Therefore, the operating clocks of the shift register 21, the shift register 22, and the data processing circuit 23 of the second-stage slave device 302 are all the system clock CLK2.

In the serial communication system 300, starting from the second-stage slave device, the clock input terminal CLKi of a subsequent-stage slave device is connected to the clock output terminal CLKo of a preceding-stage slave device, and the data output terminal Do and the clock output terminal CLKo of a last-stage slave device are floating. Although not shown in the figure, the internal structure of each of the multiple slave devices in the serial communication system 300 is similar to that of the first-stage slave device 301 and will not be described in detail here. The multiple slave devices in the serial communication system 300 sequentially obtain their own received data and each forward data to a subsequent-stage slave device in a manner similar to that of the first-stage slave device 301 and the second-stage slave device 302, thereby sequentially transmitting the communication data D0 of the master device 310 to the multiple slave devices connected in series.

Optionally, the clock transmission circuit 26 can also process the system clock CLK2 before forwarding the system clock CLK2. For example, the clock transmission circuit 26 includes a buffer and a delay compensation circuit for improving driving capability.

In this embodiment, the signal direction of the clock transmission circuit 26 can be pre-configured as one of a signal receiving direction and a signal output direction, and the clock output terminal CLKo of each slave device can be multiplexed as an input terminal and an output terminal. Therefore, the number of clock input terminals of each slave device can be reduced from 2 to 1. In the first-stage slave device, the signal direction of the clock transmission circuit 26 is pre-configured as a signal receiving direction, so the clock output terminal CLKo of the first-stage slave device 301 serves as an input terminal to receive the system clock CLK2. Starting from the second-stage slave device, the clock input terminal CLKi of the second-stage slave device 302 receives the system clock CLK2, and the signal direction of the clock transmission circuit 26 is pre-configured as a signal output direction, so the clock output terminal CLKo of the second-stage slave device 302 serves as an output terminal to provide the system clock CLK2.

Optionally, the default signal direction of the clock transmission circuit 26 of the first-stage slave device 301 and the second-stage slave device 302 is a signal receiving direction. Before the serial communication phase starts, the serial communication system 300 also includes a configuration phase, during which, for example, the master device 310 provides a first-stage configuration parameter P0, the communication clock CLK1, and the system clock CLK2. Among the multiple slave devices in the serial communication system, only the first-stage slave device 301 can receive the first-stage configuration parameter P0 and the communication clock CLK1, so the first-stage slave device 301 can maintain the signal direction of the clock transmission circuit 26 as a signal receiving direction according to the received signals. After completing its own parameter configuration, the first-stage slave device 301 sends a subsequent-stage configuration parameter P1 to the second-stage slave device 301. The second-stage slave device 302 can receive the subsequent-stage configuration parameter P1 and the system clock CLK2, so the second-stage slave device 302 can change the signal direction of the clock transmission circuit 26 to a signal output direction according to the received signals. In the configuration phase as mentioned above, the first-stage slave device 301 and the second-stage slave device 302, for example, write the configuration parameters into the storage device. In the serial communication phase, the first-stage slave device 301 and the second-stage slave device 302 respectively read a corresponding configuration parameter to obtain the signal direction of the clock transmission circuit 26.

The operating timing of the serial communication system according to the second embodiment is the same as that of the serial communication system according to the first embodiment and will not be described in detail here. Compared with the first embodiment, the serial communication system according to the second embodiment can further reduce the number of clock input terminals of the slave devices in the serial communication system.

FIG. 12 shows a flowchart of a serial communication method for slave devices in the serial communication system shown in FIG. 9. The multiple slave devices in the serial communication system 300, no matter the first-stage slave device or a subsequent-stage slave device after the first-stage slave device, each execute the serial communication method shown in FIG. 12.

The following detailed description is provided by taking the first-stage slave device 301 and the second-stage slave device 302 as examples.

The first-stage slave device 301 is connected to the master device 310 to receive the data signal D0, the communication clock CLK1, and the system clock CLK2. The first-stage slave device 301 receives the communication clock CLK1 as the first clock signal and the system clock CLK2 as the second clock signal.

The second-stage slave device 302 is connected to the first-stage slave device 301 to receive data signal D1, and is connected to the master device 301 to receive the system clock CLK2. The second-stage slave device 302 receives a single clock signal. It should be noted that, unlike the first-stage slave device 301, the first clock signal received by the second-stage slave device 302 is already converted into the system clock CLK2.

In step S11, the first-stage slave device 301 and the second-stage slave device 302 respectively receive data based on the first clock signal.

The shift register 21 in the first-stage slave device 301 is coupled to the clock input terminal CLKi to receive the communication clock CLK1, so the operating clock of the shift register 21 is the communication clock CLK1. The shift register 21 shifts the communication data D0 according to the timing of the communication clock CLK1 to receive the communication data D0 bit by bit. For example, the shift register 21 receives one bit of the communication data D0 in each clock cycle of the communication clock CLK1.

The shift register 21 in the second-stage slave device 302 is coupled to the clock input terminal CLKi to receive the system clock CLK2, so the operating clock of the shift register 21 is the system clock CLK2. The shift register 21 shifts the communication data D1 according to the timing of the system clock CLK2 to receive the communication data D1 bit by bit. For example, the shift register 21 receives one bit of the communication data D1 in each clock cycle of the system clock CLK2.

In step S12, the first-stage slave device 301 and the second-stage slave device 302 are respectively configured to detect the signal direction of the clock transmission circuit.

In the serial communication system 300, the signal direction of the clock transmission circuit 26 of each of the multiple slave devices is pre-configured in the configuration phase of the serial communication phase, where the signal direction of the clock transmission circuit 26 in the first-stage slave device 301 is configured as a signal receiving direction, and the signal direction of the clock transmission circuit 26 in the second-stage slave device 302 is configured as a signal output direction. The first-stage slave device 301 and the second-stage slave device 302 respectively read a corresponding configuration parameter of the clock transmission circuit 26 to detect the signal direction of the clock transmission circuit.

In step S13, the first-stage slave device 301 and the second-stage slave device 302 respectively determine the signal direction of the clock selection circuit 24.

The clock selection circuit 24 of the first-stage slave device 301 reads the configuration parameter of the clock transmission circuit 26, thus detecting that the signal direction of the clock selection circuit 24 is a signal receiving direction. Therefore, the first-stage slave device 301 continues to execute steps S14 and S15.

In step S14, the first-stage slave device 301 receives the first clock signal and the second clock signal via the clock input terminal CLKi and the clock output terminal CLKo, respectively.

The clock selection circuit 24 of the first-stage slave device 301 is coupled to the clock input terminal CLKi to receive the communication clock CLK1 and receives the system clock CLK2 via the clock output terminal CLKo. The clock transmission circuit 26 of the first-stage slave device 301 is used to transmit the system clock CLK2 from the clock output terminal CLKo to the clock selection circuit 24.

In step S15, the first-stage slave device 301 selects the second clock signal as the operating clock for data processing and data transmission.

In a case that the signal direction of the clock transmission circuit 26 is detected as a signal receiving direction, the operating clock selected by the clock selection circuit 24 is the system clock CLK2. Therefore, the operating clock used for data reception in the first-stage slave device 301 is the communication clock CLK1, but the operating clock used for data processing and data transmission is the system clock CLK2.

The clock selection circuit 24 of the second-stage slave device 302 reads the configuration parameter of the clock transmission circuit 26, thus detecting that the signal direction of the clock selection circuit 24 is a signal output direction. Therefore, the second-stage slave device 302 continues to execute steps S16 and S17.

In step S16, the second-stage slave device 302 selects the first clock signal as the operating clock for data processing and data transmission.

The second-stage slave device 302 receives a single clock signal, i.e., the system clock CLK2, via the clock input terminal CLKi. The operating clock selected by the clock selection circuit 24 is the first clock signal, i.e., the system clock CLK2. Therefore, the operating clocks for data reception, data processing, and data transmission in the second-stage slave device 302 are all the system clock CLK2.

In step S17, the second-stage slave device 302 transmits the first clock signal to a subsequent-stage slave device.

The clock transmission circuit 26 of the second-stage slave device 302 is used to transmit the system clock CLK2 from the clock selection circuit 24 to the clock output terminal CLKo. Since the second-stage slave device 302 selects the system clock CLK2 as the first clock signal, the first clock signal received by the first clock input terminal CLKi of the subsequent-stage slave device is already converted into the system clock CLK2.

It should be noted that in the description of the present disclosure, it should be understood that the terms “upper,” “lower,” “inner,” etc., indicating directions or positional relationships, are only for the purpose of describing the present disclosure and simplifying the description, and are not intended to indicate or imply that the components or elements referred to must have specific orientations, be constructed, and operate in specific orientations. Therefore, they should not be understood as limitations to the present disclosure.

Furthermore, in this document, the terms “comprising”, “including”, or any other variations thereof are intended to cover non-exclusive inclusion, so that a process, method, article, or device that includes a series of elements not only includes those elements but also includes other elements not explicitly listed, or elements inherent to such a process, method, article, or device. Without more limitations, the elements defined by the phrase “comprising a . . . ” do not exclude the presence of additional identical elements in the process, method, article, or device that includes the element.

Finally, it should be noted that the above embodiments are merely examples provided for clearly illustrating the present disclosure and are not intended to limit the implementation of the present disclosure. Those skilled in the art can make other different forms of changes or modifications based on the above description. It is not necessary or possible to exhaust all the implementation methods here. The obvious changes or modifications derived from this are still within the scope of protection of the present disclosure.

1. A serial communication device, comprising:
a first shift register, used to receive data in accordance with one of a communication clock and a system clock;
a second shift register, used to transmit data in accordance with the system clock; and
a data processing circuit, configured to process data in accordance with the system clock,
wherein the communication clock is a clock signal that is active during a serial communication phase and inactive during an idle phase, and the system clock is a clock signal that is continuously effective during both the serial communication phase and the idle phase.

2. The serial communication device according to claim 1, wherein, in a case that the serial communication device is the first-stage slave device in the serial communication system, the serial communication device is configured to receive the communication clock and the system clock.

3. The serial communication device according to claim 1, wherein, in a case that the serial communication device is a subsequent-stage slave device after the first-stage slave device in the serial communication system, the serial communication device is configured to only receive the system clock.

4. The serial communication device according to claim 1, further comprising:
a first clock input terminal, for receiving a first clock signal, the first clock signal being one of the communication clock and the system clock;
a second clock input terminal, for receiving a second clock signal or being coupled to a fixed voltage level, the second clock signal being the system clock;
a clock output terminal, for transmitting the system clock; and
a clock selection circuit, configured to select the system clock in accordance with a voltage level state at the second clock input terminal, and provide the selected system clock to the second shift register and the data processing circuit,
wherein the first shift register is coupled to the first clock input terminal to receive the first clock signal, and is configured to receive data in accordance with the first clock signal.

5. The serial communication device according to claim 4, wherein, in a case that the serial communication device is the first-stage slave device in the serial communication system, the first clock input terminal of the serial communication device is configured to receive the communication clock, and the second clock input terminal is configured to receive the system clock.

6. The serial communication device according to claim 4, wherein, in a case that the serial communication device is a subsequent-stage slave device after the first-stage slave device in the serial communication system, the first clock input terminal of the serial communication device is configured to receive the system clock, and the second clock input terminal is coupled to the fixed voltage level.

7. (canceled)

8. (canceled)

9. The serial communication device according to claim 4, further comprising:
a clock processing circuit, configured to process the system clock before the system clock is transmitted.

10. The serial communication device according to claim 1, further comprising:
a clock input terminal, for receiving a first clock signal, the first clock signal being one of the communication clock and the system clock;
a clock output terminal, for receiving a second clock signal or transmitting the first clock signal, the second clock signal being the system clock;
a clock transmission circuit, configured to perform signal forwarding according to a pre-configured signal direction, thereby multiplexing the clock output terminal as one of an input terminal and an output terminal; and
a clock selection circuit, configured to select the system clock according to the signal direction of the clock transmission circuit, and provide the selected system clock to the second shift register and the data processing circuit,
wherein the first shift register is coupled to the clock input terminal to receive the first clock signal, and is configured to receive data in accordance with the first clock signal.

11. (canceled)

12. The serial communication device according to claim 10, wherein, in a configuration phase before serial communication, the signal direction of the clock transmission circuit in the serial communication device is pre-set as a signal receiving direction, and the serial communication device is configured to receive a configuration parameter and write the configuration parameter into the serial communication device.

13. The serial communication device according to claim 12, wherein, in a serial communication phase, the serial communication device is configured to read the configuration parameter and sets the signal direction of the clock transmission circuit according to the configuration parameter.

14. The serial communication device according to claim 13, wherein, in a case that the serial communication device is the first-stage slave device in the serial communication system, the signal direction of the clock transmission circuit is a signal receiving direction, and the clock input terminal of the serial communication device is configured to receive the communication clock, and the clock output terminal is configured to receive the system clock.

15. (canceled)

16. The serial communication device according to claim 13, wherein, in a case that the serial communication device is a subsequent-stage slave device after the first-stage slave device in the serial communication system, the signal direction of the clock transmission circuit is a signal output direction, and the clock input terminal of the serial communication device is configured to receive the system clock, and the clock output terminal is configured to transmit the system clock.

17. (canceled)

18. (canceled)

19. The serial communication device according to claim 9, wherein the clock transmission circuit is configured to process the system clock before transmitting the system clock.

20. The serial communication device according to claim 1, wherein the data processing circuit is configured to receive the communication data from the first shift register, cache a portion of the communication data as received data, and send another portion of the communication data to the second shift register as transmitted data.

21. The serial communication device according to claim 1, wherein the serial communication device is configured to forward the transmitted data during the serial communication phase and forward an idle identifier during the idle phase.

22. The serial communication device according to claim 21, wherein the idle identifier is a continuous series of binary digits 0.

23. The serial communication device according to claim 1, wherein the serial communication device is part of an LED driver circuit, the LED driver circuit receives display data in accordance with one of the communication clock and the system clock, and during a frame cycle of continuous image frames, uses the system clock to convert the display data into driving currents for LEDs in a corresponding image area.

24. A serial communication system, comprising:
a master device, configured to provide a communication data, a communication clock, and a system clock; and
a plurality of slave devices, each of which includes the serial communication device according to claim 1,
wherein the plurality of slave devices are connected in series, and the first-stage slave device of the plurality of slave devices is coupled to the master device, and the plurality of slave devices are configured to receive data in accordance with one of the communication clock and the system clock.

25. The serial communication system according to claim 24, wherein the first-stage slave device of the plurality of slave devices is configured to receive data in accordance with the communication clock, and process and transmit data in accordance with the system clock; and/or,
a subsequent-stage slave device of the plurality of slave devices after the first-stage slave device is used to receive, process, and transmit data in accordance with the system clock.

26. (canceled)

27. A serial communication method, for data communication in a serial communication system comprising a master device and a plurality of slave devices, wherein the serial communication method comprises:
in the first-stage slave device of the plurality of slave devices, receiving data in accordance with a communication clock, and processing and transmitting data in accordance with a system clock; and
in a subsequent-stage slave device of the plurality of slave devices after the first-stage slave device, receiving, processing, and transmitting data in accordance with the system clock,
wherein the communication clock is a clock signal that is active during a serial communication phase and inactive during an idle phase, and the system clock is a clock signal that is continuously effective during both the serial communication phase and the idle phase.

28-36. (canceled)
